(19) United States
(12) Patent Application Publication
(10) Pub. No.: US 2005/0182684 A1
(43) Pub. Date: Aug. 18, 2005

(54) Method and system for economical e-commerce shopping token for validation of online transactions

(75) Inventors: Christopher James Dawson, Arlington, VA (US); Vincenzo Valentino Di Luoffo, Sandy Hook, CT (US); Craig William Fellenstein, Brookfield, CT (US); Rick Allen Hamilton II, Charlottesville, VA (US)

Correspondence Address: IBM CORPORATION (RUS), C/O SIEGESMUND & ASSOCIATES, 4627 NORTH CENTRAL EXPRESSWAY, SUITE 2000, DALLAS, TX, 75206, US

(73) Assignee: International Business Machines Corporation, Armonk, NY (US)

(21) Appl. No.: 10/777,717

(22) Filed: Feb. 12, 2004

(51) Int. Cl. G06F 17/60

(52) U.S. Cl. 705/26

(57) ABSTRACT

A method for creating a read-only shopping token that is a digitally signed record of the contract between the buyer and the seller. The shopping token starts as an XML file containing the seller's personal information, information regarding the goods purchased, and the seller's terms for the transaction. The buyer adds his personal information to the XML file. The buyer and seller are both given an opportunity to review and modify the terms. When the buyer and seller agree to the terms, they both digitally sign the XML file. Once both the buyer and the seller have digitally signed the XML file, the XML file is converted into a shopping token. The shopping token is in a format such that a user cannot modify or copy-and-paste the subject matter of the shopping token. Any attempt to alter the shopping token renders the digital signatures invalid.

### FIELD OF THE INVENTION

The present invention is directed generally at an automated method for creating a contract and specifically at a method for creating a contract between the buyer and the seller of an e-commerce transaction.

### BACKGROUND OF THE INVENTION

The Internet and online commerce have revolutionized the way people shop. Shopping over the Internet is both more convenient and more cost effective than shopping at a physical store. However, one of the major problems with shopping over the Internet is that there is not a reliable method for proving what goods were ordered, the promised delivery time, and other important purchase details.

Purchases made in a physical store are different from online purchases. When making a purchase in a physical store, the buyer knows what he is purchasing because he can pick up and examine the item. There is no delay in shipment because delivery and payment of the item occur simultaneously. When the buyer pays for the item, he receives a receipt, which is proof of purchase of the item. In addition to a transaction identification number, a receipt from a physical store typically has one or more authenticating features such as a watermark. If the buyer attempts to return the item, the seller can verify the authenticity of the receipt through the authenticating features on the receipt. When the authenticating features are present on the receipt, the seller does not have to look up a transaction number in order to verify the authenticity of the receipt.

By contrast, online buyers are not able to pick up and examine the item purchased. Instead, the buyer relies on illustrations, pictures, or descriptions of the item by the seller. In an online transaction, there is a delay between payment and receipt because the buyer pays for the item, then the seller ships the item, and then the buyer receives the item. In an online transaction, the seller typically emails the receipt to the buyer or presents the receipt in the form of a printable webpage. The email or webpage receipt does not contain authenticating features that are present in the physical store receipt. An online buyer can easily modify the email or webpage receipt by copying the text of the email or webpage to a word processing document and then changing the terms of the receipt. If an online buyer attempts to return the item to the seller, the seller has no way of verifying authenticity of the receipt by merely looking at the receipt. In order to verify authenticity, the seller must look up the transaction identification number. Therefore, a need exists for a method of creating a receipt for an online transaction that cannot be modified by either party after the buyer and seller agree on the contract terms.

One of the biggest problems with online shopping is that the seller does not specify exactly when the item will be shipped or exactly when the buyer can expect to receive the item before the buyer agrees to purchase the item. This is frustrating for potential buyers to whom the delivery date is an important issue when making an online purchase. For example, if the item purchased is a gift for an event such as a birthday, anniversary, or special holiday such as Christmas or Hanukkah, then the item has significantly more value if received before the holiday or event rather than after the holiday or event. Even when a purchase is not for a specific holiday or event, buyers are more comfortable with online purchasing when the buyer has an affirmative statement regarding the terms and details regarding the goods purchased. Therefore, a need exists for a method for recording the purchase and delivery details for an online transaction in the contract before the buyer agrees to purchase the item.

When businesses purchase goods online from other businesses, the buyers are typically purchasing large quantities of goods. For example, an automobile manufacturer may purchase engine bearings in 100,000 unit lots from a bearing manufacturer. In that case, complex computer applications determine the terms of the agreement between the buyer and seller. These terms include the quantity purchased, the purchase price, expected delivery date, shipping terms, arbitration clauses, and many other details of the contract between the parties. While these complex computer applications are adequate for business-to-business transactions, they may be too expensive for business-to-consumer or consumer-to-consumer transactions. Therefore, a need exists for a method for recording the contract details between a buyer and a seller in a business-to-consumer or consumer-to-consumer transaction.

The use of trusted third parties in online purchases is well known in the art. For example, the online financial institution PAYPAL® allows online buyers to pay for goods through the PAYPAL® website. When the buyers pay for goods through the website, the buyers have a record of the transfer of funds from the buyer to the seller. Similarly, VERISIGN® is an online certificate authority that certifies public keys to parties desiring to use public key cryptography such as encryption and/or digital signatures. Both the buyer and the seller are more comfortable with the online transaction when part or all of the transaction occurs through a trusted third party. Therefore, a need exists in the art for a method of verifying the details of the terms of a contract in a business-to-consumer or consumer-to-consumer transaction through a third party.

In most commercial and consumer transactions, the buyer is the party who needs to prove the terms of the contract to the seller. If the seller has a policy regarding the warranty, service, or return of the goods, it is in the buyer's best interest that these details be included in the terms of the contract. It is also in the buyer's best interest for the buyer or a trusted third party to store the receipt electronically in a properly indexed file. Therefore, a need exists for a method of storing an electronic receipt containing the warranty, service, and return details on the buyer's computer or on a trusted third party's computer.

The prior art has addressed the issue of improving the online purchasing process. For example, U.S. Patent Application Publication 2003/0093372 (the '372 application) entitled “Customizable Offline Payment Plug-In for Payment Server” discloses a method for supporting uncommon payment protocols. The '372 application discloses a method by which a seller can accept payment methods such as collect on delivery (COD). However, the '372 application does not disclose a method for capturing other important contract details and terms regarding an online transaction. Therefore, a need still exists for a method for capturing and verifying the details and terms regarding an online transaction.

U.S. Pat. No. 6,330,550 (the '550 patent) entitled “Cross-Media Notification for E-Commerce” discloses a method for facilitating a secure transaction between two parties. The '550 patent discloses a method that utilizes user identification codes to secure the transaction. However, the '550 patent does not disclose a method for capturing other important contract details and terms regarding an online transaction. Therefore, a need still exists for a method for capturing the details and terms regarding an online transaction.

PCT application publication WO 02/35758 A2 (the '758 application) entitled “Identity Insurance Transaction Method” discloses a method for verifying the identity of a party to a transaction. The '758 application discloses a method by which one party can verify the identity of another party in an online transaction. While the '758 application makes online buyers more comfortable with the purchasing process, the '758 application does not disclose a method for recording all of the details and terms regarding an online transaction. Therefore, a need still exists for a method for recording the details and terms regarding an online transaction.

Consequently, a need exists in the art for a method for recording the contract details between a buyer and a seller in a business-to-consumer or consumer-to-consumer transaction before the buyer agrees to purchase the goods. The need extends to a method for electronically recording the purchase and delivery details for an online transaction with the buyer or a third party. A need also exists for a method of verifying the details, such as the warranty, service, and return policies, of a contract in a business-to-consumer or consumer-to-consumer transaction. Finally, a need exists for a method of creating a receipt for an online transaction that is not modifiable by either party after the parties agree on the contract terms.

### SUMMARY OF THE INVENTION

The present invention, which meets the needs identified above, is a method for creating a read-only shopping token that is a digitally signed record of the contract between the buyer and the seller. The software embodiment of the present invention is a Shopping Token Program (STP) that creates an XML file for the shopping token. The STP adds the seller's personal information, information regarding the goods purchased, and the seller's terms for the transaction to the XML file. The buyer then adds his personal information to the XML file. The buyer and seller are then given an opportunity to review the terms in the XML file. If the parties do not agree with the terms of the contract, the STP allows the parties to modify the terms of the contract. When the buyer and seller agree on the terms of the contract, then the buyer and seller both digitally sign the XML file.

Once both the buyer and the seller have digitally signed the XML file, the STP converts the XML file into a shopping token. The shopping token is a read-only document stored on the buyer's computer, the seller's computer, and/or on a trusted third party website. The shopping token is in a format such that a user cannot copy-and-paste the subject matter of the shopping token. In other words, the STP encrypts the shopping token under its own key so that no one can read the encoding. Any attempt to alter the shopping token renders the digital signatures invalid. Thus, the shopping token is affirmative proof of the terms and details of the agreement between the parties, including the payment type information, delivery terms, and any other contract terms the parties decide to add to the shopping token.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an illustration of a computer network used to implement the present invention;

FIG. 2 is an illustration of a computer, including a memory and a processor, associated with the present invention;

FIGS. 3A and 3B are illustrations of the interaction of the parties involved with the present invention;

FIG. 4 is an illustration of the logic of the Shopping Token Program (STP) of the present invention; and

FIG. 5 is an illustration of the shopping token created by the present invention.

### DETAILED DESCRIPTION OF THE PREFERRED EMBODIMENT

As used herein, the term “buyer” shall mean a person or organization that seeks or acquires goods from a seller through purchase or lease.

As used herein, the term “computer” shall mean a machine having a processor, a memory, and an operating system, capable of interaction with a user or other computer, and shall include without limitation desktop computers, notebook computers, personal digital assistants (PDAs), servers, handheld computers, and similar devices.

As used herein, the term “digital signature” shall mean a signature by either a buyer or a seller that has been authenticated using Public Key Cryptography.

As used herein, the term “goods” shall mean business or consumer goods or services.

As used herein, the term “Public Key Cryptography” shall mean an asymmetric scheme for verifying the source of a signature that uses a pair of keys for encryption in which the sender uses the private key to create a unique electronic number that can be read by anyone possessing the corresponding public key.

As used herein, the term “read only” shall mean a document that cannot be modified by a buyer or a seller.

As used herein, the term “seller” shall mean a person or an organization that sells goods over the Internet.

As used herein, the term “shopping token” shall mean an XML document that contains the agreement between the buyer and the seller in which the buyer and seller can initially modify the terms within the document, and that becomes a read only document when both the buyer and the seller have added their digital signatures to the document.

FIG. 1 is an illustration of computer network 90 associated with the present invention. Computer network 90 comprises local computer 95 electrically coupled to network 96. Local computer 95 is electrically coupled to remote computer 94 and remote computer 93 via network 96. Local computer 95 is also electrically coupled to server 91 and database 92 via network 96. Network 96 may be a simplified network connection such as a local area network (LAN) or may be a larger network such as a wide area network (WAN) or the Internet. Furthermore, computer network 90 depicted in FIG. 1 is intended as a representation of a possible operating network containing the present invention and is not meant as an architectural limitation.

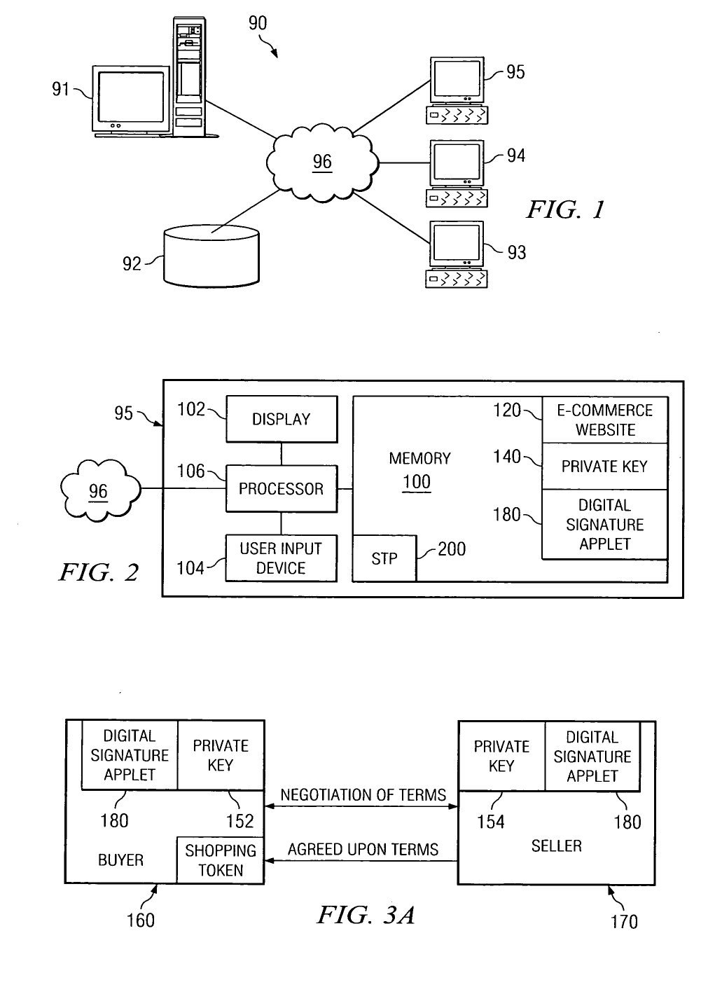

The internal configuration of a computer, including connection and orientation of the processor, memory, and input/output devices, is well known in the art. The present invention is a methodology that can be embodied in a computer program. Referring to FIG. 2, the methodology of the present invention is implemented on software by Shopping Token Program (STP) 200. STP 200 described herein can be stored within the memory of any computer depicted in FIG. 1. Alternatively, STP 200 can be stored in an external storage device such as a removable disk, a CD-ROM, or a USB storage device. Memory 100 is illustrative of the memory within one of the computers of FIG. 1. Memory 100 also contains e-commerce website 120, private key 140, and digital signature applet 180. The present invention may interface with e-commerce website 120, private key 140, and digital signature applet-180 through memory 100. As part of the present invention, memory 100 can be configured with STP 200. Processor 106 can execute the instructions contained in STP 200. Processor 106 is also able to display data on display 102 and accept user input on user input device 104. Processor 106, user input device 104, display 102, and memory 100 are part of a computer such as local computer 95 in FIG. 1. Processor 106 can communicate with other computers via network 96.

In alternative embodiments, e-commerce website 120, private key 140, digital signature applet 180, and STP 200 can be stored in the memory of other computers. Storing e-commerce website 120, private key 140, digital signature applet 180, and STP 200 in the memory of other computers allows the processor workload to be distributed across a plurality of processors instead of a single processor. Further configurations of e-commerce website 120, private key 140, digital signature applet 180, and STP 200 across various memories are known by persons of ordinary skill in the art. The present invention may be a method, a stand alone computer program, or a plug-in to an existing computer program. Persons of ordinary skill in the art are aware of how to configure computer programs, such as those described herein, to plug into an existing computer program.

E-commerce website 120 described herein is a website that is accessible via the Internet. E-commerce website 120 sells goods over the Internet. E-commerce website 120 typically has goods displayed for buyer selection. E-commerce website 120 also contains shipping, payment, and other terms that may be incorporated into shopping token 156 of the present invention.

Public key 140 described herein is part of the Public Key Cryptography encryption process. A trusted third party certifies public keys 140 for the buyer and the seller. The certificates are trusted by each party when they are used for digitally signing the shopping token 156. Persons of ordinary skill in the art are aware of various methods for implementing Public Key Cryptography encryption and digital signatures.

Digital signature applet 180 is a downloadable computer program that allows the user to digitally sign a document. Digital signature applet 180 uses private key 140 to allow the buyer or seller to digitally sign the XML file. The Public key is used to perform the validation of the signatures. The certificate, which includes the public key and the private key 180, may be stored on a merchant server, a smartcard, a PDA, or a computer.

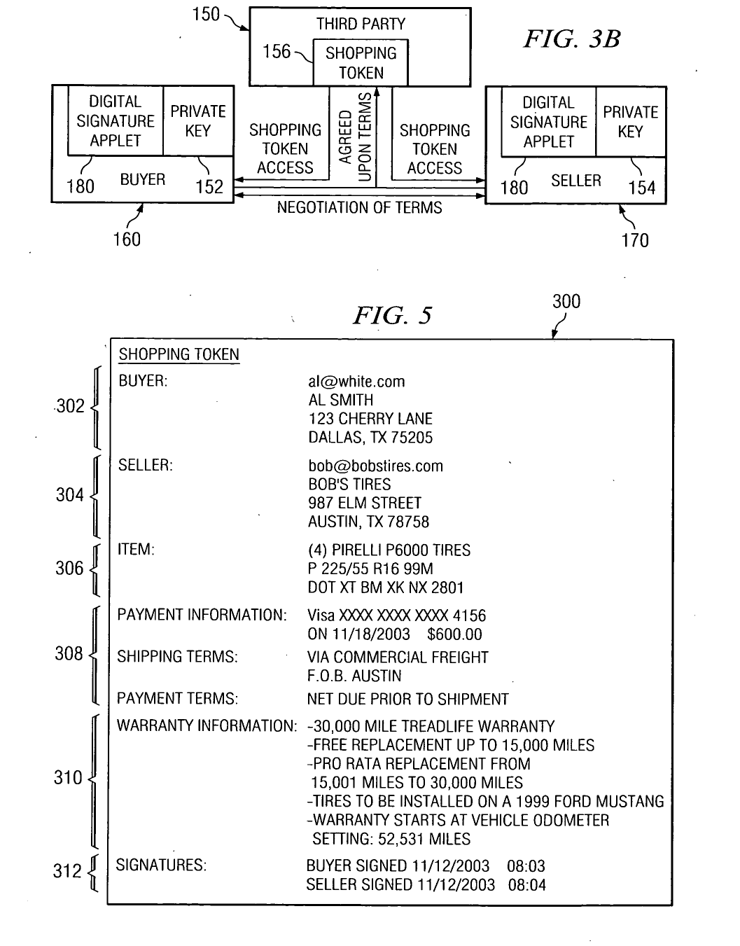

FIGS. 3A and 3B illustrate the interaction of the parties involved in the creation of the shopping token of the present invention. In FIG. 3A, buyer 160 and seller 170 create and use shopping token 156, which is stored on the buyer's computer. In FIG. 3B, buyer 160 and seller 170 create and use shopping token 156, which is stored on with third party 150. Buyer private key 152 and seller private key 154 may be like private key 120 in FIG. 2. Shopping token 156 is created when buyer 160 and seller 170 agree upon the terms of the contract and digitally sign the XML file using digital signature applet 180, buyer private key 152, and seller private key 154. Once created, shopping token 156 may be accessed by buyer 160 and seller 170 as needed.

Shopping token 156 is an Extensible Markup Language (XML) document that is digitally signed by both buyer 160 and seller 170. Neither buyer 160 nor seller 170 is able to modify shopping token 156. Any attempt by buyer 160 or seller 170 to modify shopping token 156 destroys the digital signatures in shopping token 156. Shopping token 156 is in a format such that buyer 160, seller 170, and/or any other party cannot copy-and-paste the subject matter of shopping token 156 into another document. Buyer 160 and seller 170 may save and print shopping token 156 or may access shopping token 156 stored on buyer's 160 computer, seller's 170 computer, or third party's 150 computer.

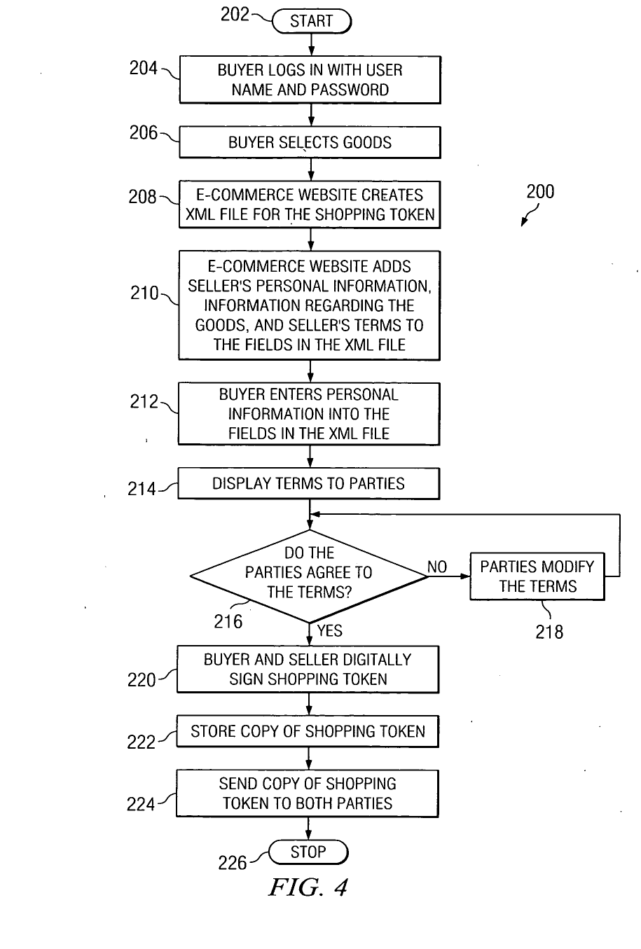

FIG. 4 illustrates the logic of Shopping Token Program (STP) 200 of the present invention. STP 200 is the process for creating shopping token 156. STP 200 starts (202) whenever a buyer launches a web browser. The buyer logs into an e-commerce website 120 with his username and password (204). The buyer then selects the goods he desires to purchase (206). When the buyer has finished selecting the goods for purchase, typically by selecting a “checkout” option, e-commerce website 120 creates the XML file for shopping token 156 (208). E-commerce website 120 adds the seller's personal information, information regarding the goods, and other terms to the fields in the XML file (210). The seller's personal information may include the seller's email address, name, address, and phone number. The information regarding the goods may be an itemized list of the goods purchased, and most typically will be the same as the description presented on e-commerce website 120. The seller's terms are stored on e-commerce website 120 and include shipping, payment, arbitration, choice of law, risk of loss, and other contract terms as determined by a person of ordinary skill in the art. The buyer then enters his personal information into the fields in the XML file (212). Alternatively, e-commerce website 120 may enter the buyer's personal information into the XML file if the buyer's personal information is available. The buyer's personal information may include the buyer's email address, name, address, and phone number. The XML file is then presented to the parties for review (214).

STP 200 then determines whether the parties agree with the terms of the contract (216). If the parties agree with the terms of the contract, STP 200 proceeds to step 220. If the parties do not agree with the terms of the contract, STP 200 allows the parties to modify the terms of the contract (218). STP 200 then proceeds to step 220. STP 200 may be configured so that the buyer and seller can individually modify the terms and send the modification to the other party for approval. Persons of ordinary skill in the art are aware of methods for synchronizing the change control in such instances so that the buyer and seller both approve the final version of the terms. When the buyer and the seller agree to the terms in the contract, they indicate their agreement by digitally signing the XML file using their respective private keys (220).

When both the buyer and the seller have digitally signed the XML document, the XML document matures into a shopping token. Once shopping token 156 has been created, shopping token 156 cannot be modified. Any attempt to modify shopping token 156 will invalidate the digital signatures on shopping token 156. STP 200 stores a copy of shopping token 156 with the buyer, seller, and/or third party (222). STP 200 indexes shopping token 156 so that it may be distinguished from other shopping tokens 156. STP 200 then sends a copy of shopping token 156 to both the buyer and the seller (224) and ends (226).

FIG. 5 is an example of one embodiment of shopping token 300. Shopping token 300 is a complete contract integrating the terms of the agreement between the buyer and the seller. Shopping token 300 comprises buyer information 302, seller information 304, item description 306, terms 308, warranty information 310, and digital signatures 312. Buyer information 302 is the buyer's personal information. Seller information 304 is the seller's personal information. Item description 306 is the itemized description of the goods sold. Terms 308 include payment information, shipping terms, payment terms, and any other terms as determined by a person of ordinary skill in the art. Payment information is the method of payment, the payment date, and the payment amount. Shipping terms identifies the carrier and the place where legal title changes from the buyer to the seller. Payment terms are the payment terms that the buyer must fulfill in order to comply with the contract. Warranty information 310 contains the warranty information for the goods sold. Signatures 312 are the digital signatures added to the XML file to create shopping token 300. Signatures 312 are created using digital signature applet 180, buyer's private key 152, and seller's private key 154.

One example of the XML schema that can be used to implement shopping token 156 of the present invention is as follows:

<?xml version=“1.0”?>
<Shopping Token>

<!--seller-->
<ADDRESS>

<LOCATION1>123 Cherry Lane</LOCATION1>
<LOCATION2>Dallas, Texas</LOCATION2>
<LOCATION3>75205</LOCATION3>
<TELEPHONE>214-555-2356</TELEPHONE>

</ADDRESS>
<!--buyer-->
<ADDRESS>

<LOCATION1>987 Elm Street</LOCATION1>
<LOCATION2>Austin, Texas</LOCATION2>
<LOCATION3>78758</LOCATION3>
<TELEPHONE>512-555-9876</TELEPHONE>

</ADDRESS>
<!--item details-->

<PRODUCT NAME>(4) Pirelli P6000 tires
</PRODUCT NAME>
<ORDER NUMBER>123</ORDER NUMBER>
<ORDER DATE>11182003</ORDER DATE>
<DELIVERY DATE >11252003</DELIVERY DATE>

<!--warranty details-->

<WARRANTY>Yes</WARRANTY>
<DATE>11182004</DATE>

</Shopping Token>

Persons or ordinary skill in the art will be aware of how to modify the code segment above to achieve a XML schema for a particular shopping token.

One of the benefits of shopping token 156 of the present invention is that shopping token 156 can be created by the buyer using a web browser and digital signature applet 180. When STP 200 is part of e-commerce website 120, the buyer does not have to install any additional software to create shopping token 156. Similarly, if e-commerce website 120 is an online auction website such as E-BAY®, then neither the buyer or the seller need to install any additional software to create shopping token 156. Shopping token 156 may then be stored with the buyer, the seller, or a trusted third party.

Another benefit of shopping token 156 of the present invention is that either the buyer or the seller can use shopping token 156 as affirmative proof of the agreement between the parties. If one party suspects that the other party has breached the contract, the parties can look to shopping token 156 to settle the dispute. Shopping token 156 also increases the functionality of e-commerce website 120 by creating an audit trail for warranty information. For example, the warranty information can be included in shopping token 156. If there is a warranty dispute, then the parties can look to shopping token 156 to identify whether a warranty existed, the terms of the warranty, and the effective dates of the warranty.

Additionally, shopping token 156 can be used for pricing promotions and pricing protection. For example, if a store has a policy of refunding 110% of the difference between the purchased price and any advertised competitors' prices within thirty days, the buyer can use shopping token 156 to prove the actual price paid and how long the price protection period lasts. For a price promotion example, when a store lowers the price of a good, the store may want to refund the difference between the previous price and the current price to anyone who purchased the good within the last thirty days. The seller can analyze his list of shopping tokens to determine who purchased the good within the last thirty days and determine the price each buyer paid. The seller can then refund the difference to the buyers using the payment information stored in shopping token 156.

Shopping token 156 of the present invention can also be used for customer surveys through a vendor rating system. For example, a system can be implemented in which potential buyers are able to view the seller's feedback rating as well as partially or fully view the individual shopping tokens. The potential buyers could then not only determine how often the seller satisfies his buyers, but also determine if the seller has had previous experience in the type and quantity of goods and the delivery period that the potential buyer is interested in.

With respect to the above description, it is to be realized that the optimum dimensional relationships for the parts of the invention, to include variations in size, materials, shape, form, function, manner of operation, assembly, and use are deemed readily apparent and obvious to one of ordinary skill in the art. The present invention encompasses all equivalent relationships to those illustrated in the drawings and described in the specification. The novel spirit of the present invention is still embodied by reordering or deleting some of the steps contained in this disclosure. The spirit of the invention is not meant to be limited in any way except by proper construction of the following claims.

1. A method for electronically creating a contract between a buyer and a seller in an online transaction by means of a shopping token that contains a plurality of agreement terms.

2. The method of claim 1 comprising:
creating an XML file; and
responsive to the addition of a buyer digital signature and a seller digital signature to the XML file, saving the XML file as the shopping token.

3. The method of claim 2 further comprising:
adding a seller's personal information to the XML file;
adding a buyer's personal information to the XML file;
adding information regarding a good to the XML file; and
adding a plurality of terms to the XML file.

4. The method of claim 2 further comprising:
presenting the terms to the buyer and the seller;
determining whether the buyer and the seller agree with the terms; and
responsive to the determination that the buyer and seller agree with the terms, adding a buyer digital signature and a seller digital signature to the XML file to create a shopping token.

5. The method of claim 4 further comprising:
responsive to the determination that the buyer and seller do not agree with the terms, accepting a modification to the terms.

6. The method of claim 2 wherein the shopping token is a created after the buyer is aware of the delivery date for the good.

7. The method of claim 2 wherein the shopping token may be configured so that the shopping token is not modifiable by the buyer or the seller.

8. The method of claim 2 wherein the shopping token is stored on a third party computer and is accessible by the buyer and the seller.

9. The method of claim 2 wherein the shopping token contains warranty information for the good.

10. The method of claim 2 wherein the shopping token is used for price protection for the good.

11. The method of claim 2 wherein the shopping token is used for price promotion for the good.

12. The method of claim 2 wherein the shopping token is used by a potential buyer to analyze a seller's history.

13. A program product for electronically creating a contract between a buyer and a seller in an online transaction by means of a shopping token that contains a plurality of agreement terms.

14. The program product of claim 13 comprising:
a computer-usable medium;
wherein the computer usable medium comprises instructions for a computer to perform steps comprising:
instructions for creating an XML file; and
responsive to the addition of a buyer digital signature and a seller digital signature to the XML file, instructions for saving the XML file as the shopping token.

15. The program product of claim 14 further comprising:
instructions for adding a seller's personal information to the XML file;
instructions for adding a buyer's personal information to the XML file;
instructions for adding information regarding a good to the XML file; and
instructions for adding a plurality of terms to the XML file.

16. The program product of claim 15 further comprising:
instructions for presenting the terms to the buyer and the seller;
instructions for determining whether the buyer and the seller agree with the terms; and
responsive to the determination that the buyer and seller agree with the terms, instructions for adding a buyer digital signature and a seller digital signature to the XML file to create a shopping token.

17. The program product of claim 16 further comprising:
responsive to the determination that the buyer and seller do not agree with the terms, instructions for accepting a modification to the terms.

18. The program product of claim 14 wherein the shopping token is a created after the buyer is aware of the delivery date for the good.

19. The program product of claim 14 wherein the shopping token may be configured so that the shopping token is not modifiable by the buyer or the seller.

20. The program product of claim 14 wherein the shopping token is stored on a third party computer and is accessible by the buyer and the seller.

21. The program product of claim 14 wherein the shopping token contains warranty information for the good.

22. The program product of claim 14 wherein the shopping token is used for price protection for the good.

23. The program product of claim 14 wherein the shopping token is used for price promotion for the good.

24. The program product of claim 14 wherein the shopping token is used by a potential buyer to analyze a seller's history.

25. A shopping token that contains a plurality of agreement terms between a buyer and a seller.

26. The shopping token of claim 25 created by steps comprising:
creating an XML file; and
responsive to the addition of a buyer digital signature and a seller digital signature to the XML file, saving the XML file as the shopping token.

27. The shopping token of claim 26 wherein the steps further comprise:
adding a seller's personal information to the XML file;
adding a buyer's personal information to the XML file;
adding information regarding a good to the XML file; and
adding a plurality of terms to the XML file.

28. The method of claim 2 further comprising:
presenting the terms to the buyer and the seller;
determining whether the buyer and the seller agree with the terms; and
responsive to the determination that the buyer and seller agree with the terms, adding a buyer digital signature and a seller digital signature to the XML file to create a shopping token.

29. The method of claim 4 further comprising:
responsive to the determination that the buyer and seller do not agree with the terms, accepting a modification to the terms.

30. The shopping token of claim 26 wherein the shopping token is a created after the buyer is aware of the delivery date for the good.

31. The shopping token of claim 26 wherein the shopping token may be configured so that the shopping token is not modifiable by the buyer or the seller.

32. The shopping token of claim 26 wherein the shopping token is stored on a third party computer and is accessible by the buyer and the seller.

33. The shopping token of claim 26 wherein the shopping token contains warranty information for the good.

34. The shopping token of claim 26 wherein the shopping token is used for price protection for the good.

35. The shopping token of claim 26 wherein the shopping token is used for price promotion for the good.

36. The shopping token of claim 26 wherein the shopping token is used by a potential buyer to analyze a seller's history.

37. An apparatus for creating a shopping token that contains a plurality of agreement terms between a buyer and a seller comprising:
means for creating an XML file;
means for adding a seller's personal information to the XML file;
means for adding a buyer's personal information to the XML file;
means for adding information regarding a good to the XML file;
means for adding a plurality of terms to the XML file;
means for presenting the terms to the buyer and the seller;
means for determining whether the buyer and the seller agree with the terms; and
responsive to the determination that the buyer and seller agree with the terms, means for adding a buyer digital signature and a seller digital signature to the XML file to create a shopping token;
responsive to the determination that the buyer and seller do not agree with the terms, means for accepting a modification to the terms;
wherein the shopping token is a created after the buyer is aware of the delivery date for the good;
wherein the shopping token may be configured so that the shopping token is not modifiable by the buyer or the seller; and
wherein the shopping token is stored on a third party computer and is accessible by the buyer and the seller.

38. The apparatus of claim 37 wherein the shopping token contains warranty information- for the good.

39. The apparatus of claim 37 wherein the shopping token is used for price protection for the good.

40. The apparatus of claim 37 wherein the shopping token is used for price promotion for the good.

41. The apparatus of claim 37 wherein the shopping token is used by a potential buyer to analyze a seller's history.
